(19) United States
(12) Patent Application Publication
(10) Pub. No.: US 2004/0129924 A1
(43) Pub. Date: Jul. 8, 2004

(54) Induction heating using dual susceptors

(76) Inventor: Philip Stark, Concord, MA (US)

Correspondence Address: Pepper Hamilton, One Mellon Bank Center 50th Floor, 500 Grant Street, Pittsburgh, PA, 15219, US

(21) Appl. No.: 10/432,278

(22) PCT Filed: Jun. 28, 2002
(86) PCT No.: PCT/US02/20681

(51) Int. Cl. H01B 1/00

(52) U.S. Cl. 252/500

(57) ABSTRACT

The invention relates to an agent for heating materials comprising (a) at least one plurality of electrically non-conductive susceptors and (b) at least one plurality of electrically conductive susceptors. Preferably the electrically non-conductive susceptors comprise micron-sized ferrimagnetic particles and the electrically conductive particles comprise ferromagnetic particles or intrinsically conductive polymer particles.

### FIELD OF THE INVENTION

The present invention relates to methods of rapid heating of material, e.g., polymeric materials, by mixing combinations of susceptors of particular compositions in the material to be heated. More specifically, the present invention provides heating agents or susceptors that heat, under an alternating magnetic field, at a rate that is significantly faster than those heating agents that have been identified in the prior art. More specifically, the present invention provides heating agents that heat at average heating rates greater than 300° C./sec (575° F./sec).

### BACKGROUND OF THE INVENTION

It is desirable to have highly efficient heating agents or susceptors for use in the heating of plastic substrates and welding to a substrate. High heating rates are desired, and sometimes demanded, for maximum production efficiency, e.g., to reduce the time and cost of production, while maintaining product quality. High heating rates are especially desired in the welding of plastic closures for liquids and food where temperatures on the order of 180° C. must be attained in 250 to 300 milliseconds. Thus, it would be desirable to have a method of rapid heating and melting of plastic substrates that can be used on production lines for sealing and welding plastic components in manufacturing facilities.

Present methods of induction heating include U.S. Pat. No. 4,969,968, issued Nov. 13, 1990 to Leatherman, et al. This patent describes the use of non-conductive, sub-micron ferric oxide (Fe₂O₃) particles, which generate heat because of hysteresis losses, with micron-sized, conductive, ferromagnetic ferrous (e.g., iron) particles, which generate heat primarily because of eddy current losses. Leatherman requires the use of integrated sub-micron-sized, non-conductive particles (e.g., Fe₂O₃) and micron-sized, conductive particles (e.g., iron), with each being a significant part of the bonding agent by weight. Leatherman's process includes the application of RF from 1.2 KHz to 7 MHz, with a preferred range of 1.8 to 4.8 MHz and 3.5 to 4 MHz being a typical range. The mixed particles of Leatherman form a substantially greater percentage by weight than the inert resin carrier, e.g., polypropylene. The second plurality of particles constitutes about twice the weight of the first plurality of particles. Leatherman teaches that, in preferred embodiments, the second particles constitute substantially 40 percent by weight of the bonding layer and said first particles constitute substantially 25 percent by weight of the bonding layer. The second particles are larger than −200 mesh (˜75 μm) and the first particles are less than 1.0 μm. In addition, Leatherman teaches the use of very high coil current, i.e., 600 amps. Leatherman teaches a maximum heating rate of 425° F./sec.

Thus, it would be desirable to have heating agents that are able to heat thermoplastics faster than presently known methods. In addition, it would be desirable to have a method of rapid heating that is more economical than the presently known methods and that can attain rapid heating rates using standard commercial equipment.

### SUMMARY OF THE INVENTION

The present invention provides heating agents that heat, under an alternating magnetic field, at a rate that is significantly faster than those heating agents that have been identified in the prior art. More specifically, the invention provides heating agents that unexpectedly heat at average heating rates greater than 300° C./sec (575° F./sec).

The shortcomings of the prior art with respect to the heating efficiencies of particulate heating agents are addressed by the present invention which comprises heating agents composed of unique mixtures of particulate matter incorporated in a resin matrix that provide exceptionally high heating rates under an applied alternating magnetic field.

The invention relates to an agent for heating materials, e.g., thermoplastics, comprising dual susceptors. The dual susceptors comprise (a) at least one plurality of electrically non-conductive, ferrimagnetic susceptors and (b) at least one plurality of electrically conductive susceptors. Preferably the electrically non-conductive susceptors comprise micron-sized ferrimagnetic particles (e.g., magnetic oxides). Examples of the electrically non-conductive particles useful in the present invention comprise iron oxides, hexagonal ferrites, or magnetically soft ferrite particles. Examples of hexagonal ferrites include compounds that have the composition SrF, Meₐ-2W, Meₐ-2Y, and Meₐ-2Z, wherein 2W is BaO:2MeₐO:8Fe₂O₃, 2Y is 2(BaO:MeₐO:3Fe₂O₃), and 2Z is 3BaO:2MeₐO:12Fe₂O₃, and wherein Meₐ is a divalent cation. Examples of the magnetically soft ferrite particles have the composition 1Me_{b}O: 1Fe₂O₃, where Me_{b}O is a transition metal oxide. Meₐ comprises Mg, Co, Mn or Zn and Me_{b} comprises Ni, Co, Mn, or Zn.

The electrically conductive susceptors used in the present invention comprise ferromagnetic particles or intrinsically conductive polymer (ICP) particles. The electrically conductive ferromagnetic particles useful in the present invention comprise elemental ferromagnetic particles or ferromagnetic alloys. Examples of ferromagnetic, electrically conductive particles comprise nickel, iron, and cobalt, and combinations thereof or of their alloys. Preferably the particles are ferromagnetic. Examples of ICPs include, but are not limited to, polyaniline (PAni), polypyrrole (PPy), polythiophene (PTh), polyethylenedioxythiophene, and poly(p-phenylene vinylene). The particles, either the electrically conductive particles and/or non-conductive particles, may be irregularly-shaped, spherically-shaped or in flake form. One of ordinary skill in the art can readily select the desired shape. In preferred embodiments the ferrimagnetic particles have a size of from about 1.0 μm to about 50 μm and the ferromagnetic particles have a size of from about 5 μm to about 100 μm, more preferably, from about 10 μm to about 50 μm.

The electrically non-conductive particles comprise from about 10^{v}/ₒ (20 ^{w}/ₒ) to about 30^{v}/ₒ (58 ^{w}/ₒ) of the heating agent. The electrically conductive particles comprise from about 5^{v}/ₒ to about 15^{v}/ₒ of the heating agent.

The invention also relates to a welding agent comprising (a) a matrix material and (b) an agent for heating the material, wherein the agent comprises dual susceptors. The dual susceptors comprise (1) at least one plurality of electrically non-conductive, ferrimagnetic susceptors and (2) at least one plurality of electrically conductive, ferromagnetic susceptors. The matrix can be selected from any thermoplastic material or combinations of materials. Examples of useful matrices include, but are not limited to, polyethylene, polypropylene, polystyrene, PVC, polyacetal, acrylic (PMMA), polyamide (PA), Nylon 6, Nylon 66, polycarbonate (PC), polysulfone (PSU), polyetherimide (PEI), polyetheretherketone (PEEK), polyetherketoneketone (PEKK), polyphenylene sulfide (PPS), polyurethane (PU), polyphenylene oxide (PPO), polytetrafluorethylene (PTFE), or combinations thereof. The dual susceptors are as described above.

The invention also relates to an article of manufacture comprising (a) a matrix material and (b) an agent for heating the material, wherein the agent comprises dual particles. The dual particles comprise (1) at least one plurality of electrically non-conductive, ferrimagnetic susceptors and (2) at least one plurality of electrically conductive, ferromagnetic susceptors. Preferably the electrically non-conductive susceptors comprise micron-sized ferrimagnetic particles and the electrically conductive susceptors comprises ferromagnetic particles or ICP particles. The susceptors are set forth above and further described below. The matrix can be selected from any polymeric or ceramic type of material or combinations of materials. Examples of polymeric materials include, e.g., plastics, elastomers, adhesives, coatings and natural polymers, such as rubbers. Some examples of useful matrix materials include, but are not limited to, polyethylene, polypropylene, polystyrene, PVC, polyacetal, acrylic (PMMA), polyamide (PA), Nylon 6, Nylon 66, polycarbonate (PC), polysulfone (PSU), polyetherimide (PEI), polyetheretherketone (PEEK), polyetherketoneketone (PEKK), polyphenylene sulfide (PPS), polyurethane (PU), polyphenylene oxide (PPO), polytetrafluorethylene (PTFE), or combination thereof. The particles can be positioned on a surface of the matrix material or, alternatively, embedded in the matrix material, as necessary for the desired application. One of ordinary skill in the art can readily determine where the particles should be positioned.

The invention also relates to a method of heating a material comprising (a) providing at least one plurality of electrically non-conductive susceptors, (b) providing at least one plurality of electrically conductive susceptors, wherein the electrically non-conductive susceptors have a specific Curie temperature (T_{c}) in the material, (c) applying an alternating magnetic field to the material, wherein the susceptors in (a) generate heat due to hysteresis loss and the susceptors in (b) generate heat due to eddy current flow.

The invention further relates to a method of rapid heating of a thermoplastic material comprising (a) providing an agent for heating the material, wherein the agent comprises (1) at least one plurality of electrically non-conductive, ferrimagnetic susceptors and (2) at least one plurality of electrically conductive ferromagnetic susceptors, in a first thermoplastic material, wherein the electrically non-conductive, ferromagnetic susceptors have a specific Curie temperature (T_{c}) in the first thermoplastic material, (b) applying an alternating magnetic field to the first thermoplastic material to heat the susceptors, and (c) ceasing the application of the alternating magnetic field when the susceptors reach the desired temperature.

In methods of the present invention, the applying comprises applying an alternating magnetic field at about 2 MHz to about 30 MHz, and in preferred cases, the alternating magnetic field is applied at about 10 to about 15 MHZ.

In preferred methods, the method further comprises the step of providing a second thermoplastic material in contact with the first thermoplastic material before applying the alternating magnetic field. In yet other embodiments, the method further comprises initially placing the first thermoplastic material on an uncured or partially cured thermoset material and bonding the thermoplastic material and the thermoset material while curing the thermoset material. The method may also include initially juxtaposing the first thermoplastic material on the thermoset material, bonding the thermoplastic to the thermoset while curing the thermoset material, and juxtaposing the bonded assembly with the second material. Preferably, the second material is a second thermoset material with a second thermoplastic material and wherein the bonding comprises flowing and bonding the first and second thermoplastic materials while curing the thermoset material. In other methods, the second material is a second thermoplastic material. The second material may have the same chemical composition as the first thermoplastic material or a different chemical composition. The second thermoplastic material may have the susceptors embedded therein. In such embodiments, the susceptors may be embedded in adjacent surfaces of the first and second thermoplastic materials. The susceptors may be embedded in a surface of the first or second thermoplastic material.

In preferred methods, T_{c} of the electrically non-conductive susceptors is greater than the melting temperature of the thermoplastic material, and the magnetic field is applied so that the susceptors melt the thermoplastic material. In other embodiments, T_{c} of the susceptors is less than the melting temperature of the thermoplastic material.

In certain methods and articles of the present invention, the amount of zinc in the ferrimagnetic particles can be varied as to control the Curie temperature of the particles.

In preferred methods, the method further comprises the step of providing a second thermoplastic material in contact with the first thermoplastic material before applying the alternating magnetic field. In yet other embodiments, the method further comprises initially placing the first thermoplastic material on an uncured or partially cured thermoset material and bonding the thermoplastic material and the thermoset material while curing the thermoset material. The method may also include initially juxtaposing the first thermoplastic material on the thermoset material, bonding the thermoplastic to the thermoset while curing the thermoset material, and juxtaposing the bonded assembly with the second material. Preferably, the second material is a second thermoset material with a second thermoplastic material and wherein the bonding comprises flowing and bonding the first and second thermoplastic materials while curing the thermoset material. In other methods, the second material is a second thermoplastic material. The second material may have the same chemical composition as the first thermoplastic material or a different chemical composition. The second thermoplastic material may have the susceptors embedded therein. In such embodiments, the susceptors may be embedded in adjacent surfaces of the first and second thermoplastic materials. The susceptors may be embedded in a surface of the first or second thermoplastic material.

In preferred methods, T_{c} of the susceptors is greater than the melting temperature of the thermoplastic material, and the magnetic field is applied so that the susceptors melt the first thermoplastic material.

The invention also relates to a sealable apparatus comprising a first element having a shaped matrix and having a rim; a second element having an annular area for bonding to the rim of the first element; at least one plurality of electrically non-conductive susceptors and at least one plurality of electrically conductive susceptors disposed in the rim of the first element or in the annular area of the second element, for heating the rim or the annular area to a predetermined temperature upon application of an alternating magnetic field, for bonding the first element and the second element together. In certain embodiments the susceptors are disposed in both the rim and the annular area.

The matrix used in the sealable apparatus preferably comprises at least one thermoplastic material and can be selected from any thermoplastic material or combinations of materials. Examples of useful matrices include, but are not limited to, polyethylene, polypropylene, polystyrene, PVC, polyacetal, acrylic (PMMA), polyamide (PA), Nylon 6, Nylon 66, polycarbonate (PC), polysulfone (PSU), polyetherimide (PEI), polyetheretherketone (PEEK), polyetherketoneketone (PEKK), polyphenylene sulfide (PPS), polyurethane (PU), polyphenylene oxide (PPO), polytetrafluorethylene (PTFE), or combinations thereof. The particles can be positioned on a surface of the matrix material or, alternatively, embedded in the matrix material, as necessary for the desired application. One of ordinary skill in the art can readily determine where the particles should be positioned.

### BRIEF DESCRIPTION OF THE DRAWINGS

FIG. 1 is a top view of a heating agent in sheet or tape form comprising a mixture of electrically non-conductive, micron-sized ferrimagnetic (e.g., ferrite) particles and electrically-conductive, micron-sized ferromagnetic particles randomly dispersed in a thermoplastic matrix.

FIG. 2 is the heating curve (solid line) for 20^{v}/ₒ (36 ^{w}/ₒ) strontium ferrite and 13^{v}/ₒ (41 ^{w}/ₒ) flake nickel in high density polyethylene (HDPE). Dashed curve marks when the generator power was turned on (t=0) and then turned off at t=250 msec. Heating Rate: 1120° F./sec.

FIG. 3 is the heating curve (solid line) for 20^{v}/ₒ (36 ^{w}/ₒ) MnZn ferrite and 13^{v}/ₒ (40 ^{w}/ₒ) iron in high density polyethylene (HDPE). Dashed curve marks when the generator power was turned on (t=0) and then turned off at t=250 msec. Heating Rate: 740° F./sec.

FIG. 4 is the heating curve (solid line) for 20^{v}/ₒ (44.9 ^{w}/ₒ) MnZn ferrite and 5^{v}/ₒ (20.8 ^{w}/ₒ) Ni-Al flake in high density polyethylene (HDPE). Dashed curve marks when the generator power was turned on (t=0) and then turned off at t =250 msec. Heating Rate: 740° F./sec.

FIG. 5 is the heating curve (solid line) for 20^{v}/ₒ (46.1 ^{w}/ₒ) strontium ferrite and 5^{v}/ₒ (20.6 ^{w}/ₒ) flake nickel in high density polyethylene (HDPE). Dashed curve marks when the generator power was turned on (t=0)and then turned off at t=250 msec. Heating Rate: 760° F./sec.

### DETAILED DESCRIPTION OF THE INVENTION

The present invention provides heating agents comprising combinations of susceptors that heat, under an alternating magnetic field, at a rate that is surprisingly faster than those heating agents that have been identified in the prior art. The heating agents of the present invention heat at average heating rates greater than 300° C./sec (575° F./sec).

The present invention uses a combination of at least two susceptors and high frequency alternating magnetic fields to generate heat, which is used to bond or weld plastic substrates. For example, the welding agent of the present invention comprises multiple susceptors embedded in a plastic, e.g., thermoplastic matrix.

Both ferromagnetism in a ferromagnetic material and ferrimagnetism in a non-conductive ferromagnetic material disappears at the Curie temperature as thermal oscillations overcome the orientation due to exchange interaction, resulting in a random grouping of the atomic particles. When a non-conductive ferrimagnetic material is placed in an electromagnetic field, the hysteresis losses in the material cause its temperature to rise, eventually reaching its Curie temperature. Upon reaching its Curie temperature, the material crystal lattice undergoes a dimensional change, causing a reversible loss of magnetic dipoles. Once the magnetic dipoles are lost, the ferrimagnetic properties cease, thus halting further heating. While not intending to be bound by theory, it is believed that the rapid heating phenomenon seen in the methods and compositions of the present invention are due to the combination of the non-conductive susceptors and the second electrically conductive susceptors. The addition of the second susceptor type helps to focus the magnetic field on the non-conductive susceptors, enabling the temperature to continue to rise rapidly.

Among the important parameters in this process are the following:

1) Size and Shape of The Ferrimagnetic Hysteresis Loop:

The size and shape of the ferrimagnetic hysteresis loop are controlled by the choice of the susceptor. For example, a magnetically hard ferrite exhibits a larger hysteresis loop than does a magnetically soft ferrite. The larger the hysteresis loop, the greater is the heat that can be generated per cycle. To take advantage of the larger hysteresis loop, the strength of the applied, alternating magnetic field must be sufficiently large to permit the loop to be completely traversed in each cycle (e.g., for the susceptor to reach magnetic saturation).

2) Susceptor Loading:

The amount of susceptor used is controlled and optimized for the intended application. In the case of a thermoplastic weld material, the volume fraction of the susceptor phase and the thickness of the weld material play a direct role in the temperature achieved and the rate of heating within the thermoplastic polymer.

3) Alternate Heating Mechanisms:

The present invention takes advantage of the effect of alternate heating mechanisms to provide additional heat.

4) Particle Size:

The particle size is controlled and optimized for the intended application. Particle size affects heat transfer to the thermoplastic weld material.

5) Particle Shape:

The particle shape is controlled and optimized for the intended application. Certain shapes may exhibit unique responses to the induction field, and thus optimized heating for the application.

By manipulating these parameters as described herein, the inventors have found that the rate of heating can be increased substantially.

The term “susceptor” as used herein refers to a material that interacts with a magnetic field to generate a response, e.g., eddy currents and/or hysteretic losses. The methods and apparatus of the present invention are based on the use of dual “susceptors” that can be used to heat a polymer matrix. The susceptors are further described below.

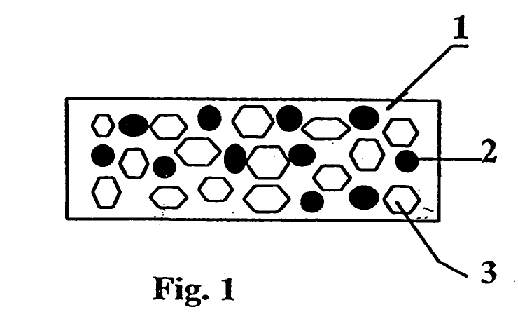

As shown in FIG. 1, the electrically non-conductive susceptors, e.g., micron-sized ferrimagnetic particles 2 and the electrically conductive susceptors, e.g., micron sized ferromagnetic particles or ICP particles 3, are dispersed in the thermoplastic host matrix 1. The susceptors can be dispersed throughout the article that will be heated, e.g., if the article is a tape that will be used to bond two pieces of thermoplastic together. Or alternatively, a portion of the article to be welded or bonded to another article or portion of the article, e.g., a rim or annular area, can be manufactured to have the susceptors embedded therein. One of ordinary skill in the art can readily determine where the susceptors should be placed to maximize the rate of heating and sealing or welding of the articles.

Preferential heating of the thermoplastic bond area during fusion is achieved by induction heating of the susceptor materials, e.g., particles 2 and 3 placed in the bond interface. This technology is amenable to production line manufacturing where rapid rates of production require rapid heating of composite structures. It would also be useful in rapid field repair of composite structures, for example, and is more cost effective in initial fabrication than presently known methods of repair.

### Susceptors

The invention relates to an agent for heating thermoplastic materials comprising dual susceptors. The susceptors comprise (a) at least one plurality of electrically non-conductive susceptors and (b) at least one plurality of electrically conductive susceptors. The methods and compositions of the present invention utilize the fact that magnetic induction heating occurs in magnetic or electrically conductive materials when they are subject to an applied alternating magnetic field. The present invention specifically takes advantage of the heating that occurs in the combination of susceptors described herein. When a current-carrying body, or coil, is placed near the susceptors of the present invention, the magnetic field caused by the current in the coil induces a current in the susceptors. In the electrically conductive magnetic susceptors of the present invention, heating occurs by both eddy current and hysteresis losses. It is eddy currents losses that dominate. In the non-conducting magnetic materials, heating occurs by hysteresis losses. In this later case, the amount of energy available for heating is proportional to the area of flux vs. field intensity hysteresis curve (B vs. H) and frequency of the alternating field. This mechanism exists as long as the temperature is kept below the Curie point (T_{c}) of the material. At the Curie point, the originally magnetic material becomes non-ferromagnetic. Thus, at its T_{c}. heating of the magnetic material ceases. Thus, as aforesaid, it was surprisingly found that the combination of these conductive and non-conductive susceptors as described herein, produces a rapid rate of heating, e.g., greater than 300° C./sec.

The methods of the present invention enable the user to achieve high rates of heating by selecting the appropriate combination of susceptors based upon the desired application. For example, one of ordinary skill in the art can control the rate of heating by controlling the ratios of the susceptors.

The dual susceptors comprise electrically non-conductive susceptors and electrically conductive susceptors. The electrically non-conductive susceptors are preferably micron-sized ferrimagnetic particles. Examples of the electrically non-conductive particles useful in the present invention, include, but are not limited to, iron oxides, hexagonal ferrites, or magnetically soft ferrites. Examples of hexagonal ferrites include compounds that have the composition SrF, Meₐ-2W, Meₐ-2Y, and Meₐ-2Z, wherein 2W is BaO:2MeₐO:8Fe₂O₃, 2Y is 2(BaO:MeₐO:3Fe₂O₃), and 2Z is 3BaO:2MeₐO:12Fe₂O₃, and wherein Meₐ is a divalent cation. Examples of the magnetically soft ferrite particles have the composition 1Me_{b}O:1Fe₂O₃, where Me_{b}O is a transition metal oxide. Meₐ comprises Mg, Co, Mn or Zn and Me_{b} comprises Ni, Co, Mn, or Zn. In preferred embodiments the electrically non-conductive particles, e.g., ferrimagnetic particles, have a size of from about 1.0 μm to about 50 μm. The electrically non-conductive particles comprises from about 10^{v}/ₒ (20 ^{w}/ₒ) to about 30^{v}/ₒ (58 ^{w}/^{o}) of the composition.

Examples of useful hexagonal ferrites include, but are not limited to those shown in Table 1:

TABLE 1

| Me—2W | Me—2Y | Me—2Z |
|---|---|---|
| Co₂Ba₁Fe₁₆O₂₆ | Co₂Ba₂Fe₁₂O₂₂ | Co₂Ba₃Fe₂₄O₄₁ |
| Co₁Zn₁Ba₁Fe₁₆O₂₆ | Co₁Zn₁Ba₂Fe₁₂O₂₂ | Co₁Zn₁ Ba₃Fe₂₄O₄₁ |
| Mg₂ Ba₁Fe₁₆O₂₆ | Mg₂Ba₂Fe₁₂0₂₂ | Mg₂ Ba₃Fe₂₄O₄₁ |
| Mg₁Zn₁Ba₁Fe₁₆O₂₆ | Mg₁Zn₁Ba₂Fe₁₂0₂₂ | Mg₁Zn₁ Ba₃Fe₂₄O₄₁ |
| Mn₂ Ba₁Fe₁₆O₂₆ | Mn₂Ba₂Fe₁₂0₂₂ | Mn₂ Ba₃Fe₂₄O₄₁ |
| Mn₁Zn₁Ba₁Fe₁₆O₂₆ | Mn₁Zn₁Ba₂Fe₁₂0₂₂ | Mn₁Zn₁ Ba₃Fe₂₄O₄₁ |

See L. L. Hench and J. K. West: “Principles of Electronic Ceramics” (John Wiley & Sons, 1990) pp. 321-325. The ferromagnetic hexagonal ferrites are also known as hexagonal ferrimagnetic oxides. Examples of preferred ferrimagnetic hexagonal ferrites include SrF, Co-2Y and Mg-2Y. A range of Curie temperatures is preferred for the susceptors to be effective in bonding and other processing of a wide range of thermoplastic and thermoset composites.

The electrically conductive susceptors useful in the present invention include ferromagnetic particles and ICP particles. The electrically conductive ferromagnetic particles can be elemental ferromagnetic particles or ferromagnetic alloys. Examples of electrically conductive particles comprise nickel, iron, and cobalt and combinations thereof and of their alloys. Preferred ferromagnetic particles have a size of from about 5 μm to about 100 μm, more preferably, from about 10 μm to about 50 μm.

ICPs are organic polymers that conduct electric currents while retaining the other typical properties commonly associated with a conventional polymer. ICPs are different from so-called “conducting polymers” that are merely a physical mixture of a non-conducting polymer with a conducting material such as metal or carbon powder. In addition to the generation of heat by hysteresis losses in the ferrimagnetic particles, eddy current losses within the electrically conductive polymer contribute additional heating to enhance the rate of heating of the heating agent. Since ICPs tend to lose their electrical conductivity at temperatures above about 200° C., heating agents utilizing ICPs are preferably used in applications in which the maximum process welding temperature is below 200° C. Examples of ICPs include, but are not limited to, polyaniline, polypyrrole, polythiophene, polyethylenedioxythiophene, and poly (p-phenylene vinylene).

The electrically conductive particles preferably have a size of from about 5 μm to about 100 μm, more preferably, from about 10 μm to about 50 μm and comprise from about 5^{v}/ₒ to about 15^{v}/ₒ of the composition.

In certain embodiments of the present invention, the Curie temperature of the ferrimagnetic particle changes in response to changing the proportion of zinc in the particle, such as Zn/Mg-2Y and Zn/Co-2Y. For example, T_{c} may be lowered by the partial substitution of Zn⁺⁺ for the divalent ions in the strontium ferrite (SrF), Mg-2Y, and Co-2Y. The substitution of Zn⁺⁺ for Mg⁺⁺ and Co⁺⁺ on “a” sites in the lattice reduces the strength of a-b interactions and decreases T_{c}. Preferably, sufficient zinc is added to the magnetically hard hexagonal ferrite to lower its T_{c} significantly while still retaining its hexagonal structure and hard magnetic properties. One of ordinary skill in the art can readily determine the amount of zinc to be added and the methods for adding it.

The addition of Zn to hexagonal ferrites decreases their Curie temperatures. As shown in co-pending application Ser. No. 09/847055, when Co-2Y was doped with 5, 10, and 15% Zn, each of the Zn additions lowered the Curie temperature of Co-2Y. The addition of 15% Zn to Co-2Y decreased T_{c} from 340° C. to approximately 300° C. The x-ray diffraction patterns of the Zn-doped materials show that even with the addition of 15% Zn, the hexagonal structure of Co-2Y is retained. At 15% Zn, T_{c} decreased from 340° C. to 300° C. It appears that the zinc additions did not significantly affect the hysteresis behavior.

The addition of Zn to Mg-2Y also reduces its Curie temperature. When Mg-2Y was synthesized with zinc atoms substituting for half the magnesium (Formula: Mg₁Zn₁Ba₂Fe₁₂O₂₂), the Zn/Mg-2Y ferrite exhibits a Curie temperature of 175° C. The addition of zinc to Mg-2Y reduces its Curie temperature from 260 to 175° C.

Other non-conducting particles comprise magnetically soft ferrite particles having the structure 1MeO: 1Fe₂O₃, where MeO is a transition metal oxide. Examples of Me include Ni, Co, Mn, and Zn. Preferred particles include, but are not limited to: (Mn,ZnO)Fe₂O₃ and (Ni,ZnO)Fe₂O₃, also referred to as MnZn and NiZn ferrites, respectively. Even though “soft” ferrites have a narrower hysteresis loop than the “hard” ferrites, efficient heating with “soft” ferrites is achievable under proper processing conditions, e.g., power level and frequency, that utilize the total hysteresis loop area.

Examples of dual susceptor formulations include, but are not limited to Strontium Ferrite/Flake Nickel; Mn-Zn Ferrite/Flake 97Ni-3Al; Mn-Zn Ferrite/Iron. Examples are shown in Table 2:

TABLE 2
Dual Susceptor Formulations with HDPE Matrix
Strontium Ferrite (HM181) and Nickel
Volume Percent (Weight Percent)

| HM181 | Nickel | HDPE |
|---|---|---|
| 10 (28.3) | 5 (25.4) | 85 (46.3) |
| 10 (20.8) | 13 (48.4) | 77 (30.8) |
| 15 (38.1) | 5 (22.8) | 80 (39.1) |
| 15 (28.8) | 13 (44.6) | 72 (26.6) |
| 20 (46.1)* | 5 (20.6)* | 75 (33.3)* |
| 20 (35.6)* | 13 (41.5)* | 67 (22.9)* |
| 30 (58.3) | 5 (17.4) | 65 (24.3) |
| 30 (46.7) | 13 (36.2) | 57 (17.1) |

Mn—Zn Ferrite (FP215) and Nickel
Volume Percent (Weight Percent)

| FP215 | Nickel | HDPE |
|---|---|---|
| 10 (27.2) | 5 (25.8) | 85 (47.0) |
| 10 (19.9) | 13 (49.0) | 77 (31.1) |
| 10 (18.6) | 15 (53.0) | 75 (28.4) |
| 15 (36.8) | 5 (23.2) | 80 (40.0) |
| 15 (27.6) | 13 (45.4) | 72 (27.0) |
| 20 (44.7)* | 5 (21.2)* | 75 (34.1)* |
| 20 (34.3) | 13 (42.3) | 67 (23.4) |
| 30 (56.9) | 5 (18.0) | 65 (25.1) |
| 30 (45.3) | 13 (37.2) | 57 (17.5) |

Mn—Zn Ferrite (FP215) - Iron
Volume Percent (Weight Percent)

| FP215 | Iron | HDPE |
|---|---|---|
| 10 (28.0) | 5 (23.5) | 85 (48.5) |
| 10 (21.1) | 13 (45.9) | 77 (33.0) |
| 15 (37.8) | 5 (21.1) | 80 (41.1) |
| 15 (29.2) | 13 (42.3) | 72 (28.5) |
| 20 (45.8) | 5 (19.2) | 75 (35.0) |
| 20 (36.1)* | 13 (39.3)* | 67 (24.6)* |
| 30 (58.1) | 5 (16.2) | 65 (25.7) |
| 30 (47.3) | 13 (34.4) | 57 (18.3) |

*Tested

Both the non-conductive susceptors, i.e., the ferrimagnetic particles, and certain of the conducting susceptors, e.g., ferromagnetic metal particles, have a T_{C}. Thus, in certain embodiments one can utilize the T_{C} of either the ferrimagnetic particles and/or the ferromagnetic particles to obtain the desired temperature and rate of heating depending on the matrix that is selected.

### Matrices

For certain embodiments of the present invention the matrix material preferably comprises any thermoplastic known in the art. Examples of polymeric materials include, e.g., plastics, elastomers, adhesives, coatings and natural polymers, such as rubbers. The plastics can comprise either thermoplastic or thermoset materials. Examples of thermoplastics (TPs) include, but are not limited to: ethenic (vinyls, polyolefins, fluorocarbons, styrenes, acrylics), polyamides, polyesters, cellulosics, acetals, polycarbonates, polyimides, and polyethers. Specific examples include, but are not limited to, polyethylene, e.g., high density polyethylene (HDPE) and low density polyethylene (LDPE), polypropylene, polystyrene, PVC, polyacetal, acrylic (PMMA), , Nylon 6, Nylon 66, polycarbonate (PC), polysulfone (PSU), polyetherimide (PEI), e.g. GE Ultem 1000, PEEK (polyetheretherketone), polyetherketoneketone (PEKK), polyphenylene sulfide (PPS), polyurethane (PU), polyphenylene oxide (PPO), polytetrafluorethylene (PTFE) or combinations thereof. Examples of thermoset materials include, but are not limited to, phenolics, unsaturated polyesters, urethanes, silicones, ureas, melamines, epoxides.

Examples of susceptor/polymer systems include, but are not limited to Strontium Ferrite/Flake Nickel in HDPE; Mn-Zn Ferrite/Flake 97Ni-3Al in HDPE; Mn-Zn Ferrite/Iron in HDPE; Mn-Zn Ferrite/Flake Nickel in HDPE; Fe₃O₄/Flake Nickel in HDPE; Fe₃O₄/Iron in HDPE; Fe₂O₃/Flake Ni in HDPE; Fe₂O₃/Iron in HDPE. In addition, the polymers can be combined with ferrimagnetic particles such as Zn/SrF, Zn/Co-2Y, Zn/Mg-2Y and mixtures of the hexagonal ferrites, and other combinations described herein and further combined with ferromagnetic particles and determined by one of ordinary skill in the art.

One aspect of the invention relates to an agent for heating a matrix, e.g., thermoplastic materials, comprising (a) at least one plurality of electrically non-conductive particles and (b) at least one plurality of electrically conductive particles. The particles may be present on a surface of the matrix, or alternatively, embedded in the matrix, depending on the desired use. For example, if two surfaces of particular articles are being bonded or welded together, then it may be desirable to have the susceptor particles embedded on only the surface of the article that is to be bonded.

Alternatively, as described herein, the susceptors may also be dispersed in a matrix to form a welding or bonding agent and applied to the surface of one or both thermoplastic articles to be welded, sealed or bonded. The welding agent can be in any desirable form, e.g., tape, spray, liquid, sheet, tube or paste, depending on the desired use. Upon application of the magnetic field, when the particles heat up, the carrier or matrix may be melted or evaporated away. Alternatively, if the entire article is to be heated according to the present methods, it would be desirable to disperse the susceptors throughout the matrix of the article. One of ordinary skill in the art can readily determine where the susceptors should be placed in order to maximize the efficiency and efficacy of the controlled temperature heating of the susceptors.

The thermoplastics containing the susceptors as described herein, can be shaped or molded into articles by methods known in the art, e.g., by extrusion, compression molding, injecting molding or film casting. The article may be fabricated by a number of different methods well known in the art. These methods include but are not limited to: (a) solution casting of the article as film or sheet, (b) extrusion compounding the article directly into film, sheet or tape form, (c) extrusion compounding the components of the article into pellets followed by compression molding the pellets into sheets or other shapes suitable for the intended application, and (d) mixing the susceptor(s) and matrix in a mixer such as the Brabender Mixer (C. W. Babender; South Hackensack, N.J.) or the Haake Rheomix Mixer (Haake USA; Paramus, N.J.) and compression molding the mixture into sheets or other shapes suitable for the intended application.

In other embodiments, the matrix comprises a ceramic type of material. Examples of useful ceramics include single oxides (e.g., alumina, chromium oxide, zirconia, titania, magnesium oxide, silica), mixed oxides (e.g., kaolinite), carbides (e.g., vandadium carbide, tantalum carbide, tungsten carbide, titanium carbide, silicon carbide, chromium carbide, boron carbide), sulfides (e.g., molybdenum disulfide, tungsten disulfide), and nitrides (e.g., boron nitride, silicon nitride).

The susceptors may be added to the matrix in any order. For example, the non-conducting susceptors can first be added to the thermoplastic mixture and then the electrically conducting susceptors can be added. Or the susceptors can be added in reverse order. While the susceptors can be first mixed and then added to the thermoplastic matrix, it is in fact preferred to add the particles separately because it eliminates the step of mixing the particles together.

### Induction Coil Design and Magnetic Field Patterns

The compositions and methods of the present invention enable the use of standard coil constructions and the use of commercially available induction generators, e.g., solid state equipment from Ameritherm. The present invention enables the use of lower coil current and higher frequencies than the prior art. The coil current used in the present invention ranges from about 50 to about 150 amps. Certain prior art inventions utilize very high coil currents, e.g., 600 amps to get the heating rates seen in the prior art. The methods of the present invention unexpectedly produce rapid heating rates at lower coil currents.

Depending on the susceptors used and the application, based on the teachings herein, one of ordinary skill in the art can readily determine the frequency and strength of the magnetic field used to induce heating in the present methods and apparatuses. Preferably the useful frequency range is from about 2 MHz to about 30 MHz and the preferred power ranges from about 1 KW to about 7.5 KW. Where the desired temperature is higher, e.g., bonding, welding or sealing applications, the frequency and power will be at the higher end of the range, e.g., from about 10 MHz to about 15 MHz. One of ordinary skill in the art can select the appropriate power and frequency depending on the susceptor and thermoplastic selected and for the desired application, i.e., heating or bonding/welding/sealing.

Depending on the susceptors used, the field generated by the induction coil influences the heating patterns of the susceptors and the field is a function of the coil geometry. Examples of coil design include solenoid, pancake, conical and Helmholtz. While these coil types are among those commonly used by industry, certain embodiments of invention may require specialized coils. For example, in certain embodiments solenoid coils are preferred because solenoid coil geometry produces a very strong magnetic field. In other embodiments, pancake coils are used. Pancake coils have been found to produce a non-uniform field with its maximum at the center. One of ordinary skill in the art can readily select the type of coil based on the teachings in the art and set forth herein.

Magnetic field strength increases with increasing number of coil turns, increasing coil current and decreasing coil-work piece separation. The factors can be readily manipulated by one of ordinary skill in the art to select combinations of these factors to obtain the desired magnetic field strength.

Solenoid coil geometry produces the strongest field of all the possible geometries. Pancake coils are most common in one-sided heating applications. Changing the coil parameters (e.g., spacing between turns or the number of turns) can change the field values, but the pattern is generally the same. Magnetic field strength increases if the coil-part separation is reduced. If the part is placed very close to the coil, one may see the heating dictated by each turn of the coil.

### Applications

The present invention has many potential applications, especially where very rapid rates of heating are required. One example of such a use is in high velocity production lines, where thermoplastic materials need to be sealed, welded, or bonded in a very short time period. For example, the heating agents of the present invention reach 180° C. within 300 msec. Such rapid rates of heating enables one to heat (e.g., seal, bond or weld) thermoplastic articles very quickly. The potential applications for the methods and compositions of the present invention are innumerable, spanning both military and commercial markets.

Examples of military uses include fabrication and repair of aircraft structures, as well as fabrication and repair of shipboard structures. Additionally, the present invention is not limited to fusion bonding of thermoset-based composites, but also could be applied to consolidation and repair of thermoplastic composites or elevated-temperature curing of thermoset adhesives, thereby reducing repair time and increasing performance.

The commercial sector could enjoy similar benefits with respect to the fabrication and repair of composite structures. For example, this technique can be used to repair aging metal structures with composite reinforcements or new bonding techniques developed for commodity resins such as polyethylene.

The compositions and methods of the present invention are useful for any application in which it is desirable to melt the matrix material, e.g., welding, sealing and/or bonding of thermoplastic materials. In such applications, T_{c} of the non-electrically conductive particles is greater than the melting temperature of the thermoplastic material. The susceptor particles can readily be selected based upon the teachings described herein.

The compositions and methods of the present invention may be used in the packaging industry, specifically for closure systems. The broad temperature range covered by the susceptors allows for use in a wide range of commercial applications, e.g., in the food packaging industry, automotive assembly lines, etc. For example, induction heating may be used in the food industry to seal lids without the use of the aluminum peel-away that is commonly used in many packages. The advantages of replacing foil with a direct polymer seal include lower cost, improved recyclability and the ability to control the bonding conditions, including temperature, of complex seal shapes, such as a thin ring on the rim of a beverage container, or a lid on a food tray. This technology can also be used for sealing bags or other similar containers for foods, including prepared foods, instant foods or ingredients.

As one example of the sealing method, a cup containing a food product may be sealed with a lid by inductively heating the dual susceptors uniformly distributed throughout or concentrated in a rim of the cup or in an annular area of the lid or both. Inductively heating the dual particles at the annular seal area while pressing the cup rim and lid together, for example with an induction heating horn, fuses and co-cures the plastic material of the cup and lid. This method can be used for any sealing application, e.g., sealing boxes or containers enclosing any type of materials. Examples of such materials include prepared foods, foodstuffs, ingredients, liquids as well as non-edible products and liquids. For example, the sealing technology can be used to seal cartridges and filters of different types, e.g., water filters, oil filters, and medical devices. One of ordinary skill in the art can readily apply the methods of the present invention to any application that requires sealing or bonding of thermoplastics. The rapid rate of heating enables the manufacture of a high volume of these products in a very short time period, thus decreasing production time, reducing costs, and increasing productivity.

In sealing or welding methods of the present invention, it may be useful to apply pressure to the two parts to be welded or bonded together. If such pressure is desirable one of ordinary skill in the art can readily determine the necessary pressure based on the application and polymer used.

Another example of a preferable use is in manufacturing aviation, auto and marine structural components: specifically, fabricated structures that comprise one polymer component welded to another polymer component. For example, the methods of the present invention can be used on production lines in the automotive industry, for sealing or welding polymer components, e.g., tail lights, etc.

The susceptors and methods of using the susceptors described herein can be applied to either one or both of the components and inductively heated to weld or seal the components together. Another use is in the repair of structures that comprise one polymer component welded to another polymer component.

In yet another embodiment, the methods of induction bonding are used to weld the seams of structures made of thermoplastic materials, for use in the field, e.g., by military forces. One example is useful for joining polyurethane skin to itself. In one embodiment, filler particles (i.e., the susceptor particles of the present invention) are dispersed into a thermoplastic matrix that heat up in the presence of a magnetic field. These particles are designed to thermally match the softening point of a variety of thermoplastic resins, into which they can be compounded.

The present invention is further illustrated by the following Examples. The Examples are provided to aid in the understanding of the invention and are not construed as a limitation thereof.

### EXAMPLES

### Example 1

High density polyethylene (HDPE) pellets were placed in a Haake Rheomix Mixer and mixed until the pellets melted, at which time strontium ferrite particles (HM181) (particle size: 1.4 μm; Supplier: Steward Ferrite; Chattanooga, Tenn.) and fine leaf nickel flake (diameter: 10-20 μm, thickness: 0.5 μm; Supplier: Novamet; Wycoff, N.J.) were added slowly to high density polyethylene in the Rheomix mixer until the entire quantity of both susceptors have been added such that the strontium ferrite was at 36 percent by weight (^{w}/ₒ) of the total mix and the flake nickel was at 41 percent by weight (^{w}/ₒ) of the total mix and thorough mixing has taken place. The mixture was then removed from the Rheomix mixer and compression molded into sheets 10 to 20 mils thick. Small sections approximately 1×1-in were cut from the sheet and mounted on glass slides. These samples were then placed inside a 5-turn, 2-in long, oval-shaped (2×½-in) solenoid coil and subjected to an 11.8 MHz alternating magnetic field. The Nova Star 1M solid state 1.0 KW induction generator (Ameritherm, Inc.; Scottville, N.Y.) was used as the power source. Coil current was approximately 80 amps. An Ircon 06F05 IR pyrometer (Ircon, Inc.; Niles, Ill.) with a response time of 10 ms and a temperature range of 200 to 600° F. (93°-315° C.) was used to measure and record temperature. Because the spot size of the pyrometer slightly impinged on the coil, the true temperature and true rate of heating were higher than the measured values. A trigger was used to mark time zero when the power was turned on. The pyrometer starts measurements at 200° F. The initial ambient temperature of the samples prior to the start of heating was 70° F.

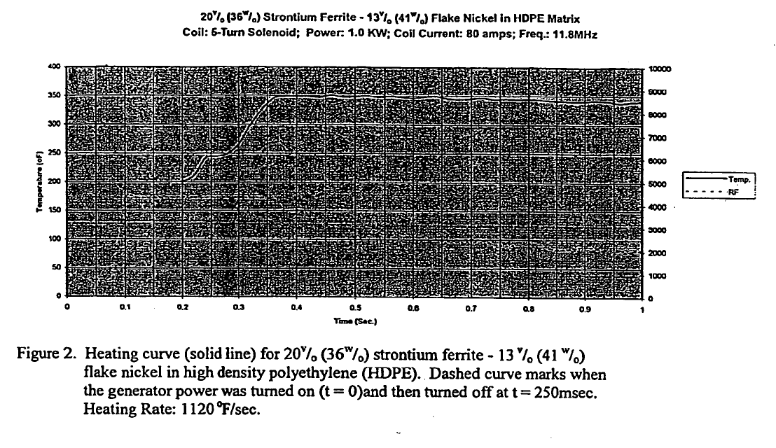

As can be seen from Table 3, heating rates ranging from 1050 to 1120° F./sec. were achieved. One of the heating curves for 20% Strontium Ferrite and 13% Flake Nickel in High Density Polyethylene is shown in FIG. 2. The heating rates achieved by the present invention were approximately 2.5 times as great as that reported by Leatherman (U.S. Pat. No. 4,969,968), at a significantly lower coil current (80 vs 600 amps).

### Example 2

Heating agents having HDPE as the matrix or host and containing the following combinations (a), (b) or (c) were fabricated in the same manner as described in Example 1

(a) 46.0 ^{w}/ₒ (20 ^{v}/ₒ) strontium ferrite (1.4 μm) and 20.6 ^{w}/ₒ (5.0 ^{v}/ₒ) Novamet flake nickel (D: 65-95 μm; t: 0.5 μm);

(b) 44.9 ^{w}/ₒ (20 ^{v}/ₒ) Mn-Zn (PowderTech FP215; Particle Size 14 μm) and 20.8 ^{w}/^{o} (5.0 ^{v}/ₒ) Novamet flake 97Ni-3Al alloy powder (D: 10-20 μm; t: 0.5 μm);

(c) 36.0 ^{w}/ₒ (20 ^{v}/ₒ) Mn-Zn (PowderTech FP215; Particle Size 14 μm) and 40.0^{w}/ₒ (13 ^{v}/ₒ) Iron [-325 mesh (<44 μm) ].

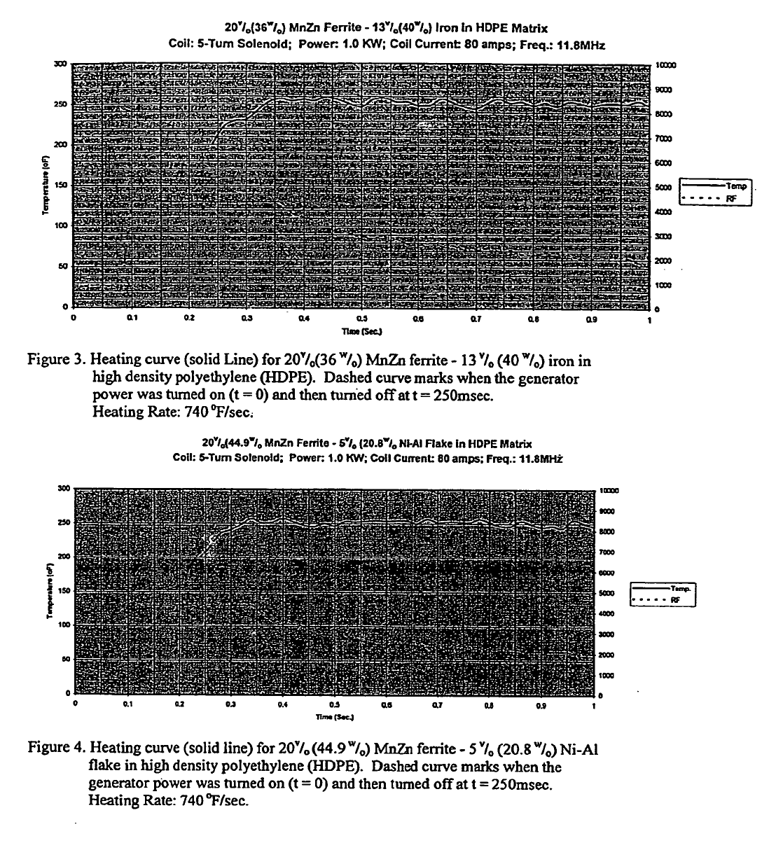

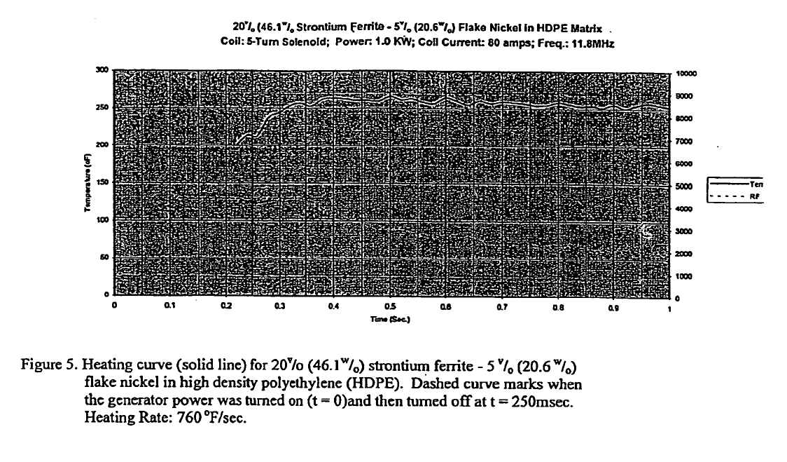

Heating tests similarly were conducted on similar size samples as described in Example 1. The heating rates achieved for the test samples of Example 2 are presented in Table 3 and the actual heating curves are shown in FIGS. 3 to 5. The rates of heating (680 - 760° F./sec) achieved by the present invention are higher than those reported in the prior art (e.g., U.S. Pat. No. 4,969,968 (142-425° F./sec)). The methods of the present invention use coil currents, which were significantly lower than in U.S. Pat. No. 4,969,968.

TABLE 3
Results of Heating Tests
Test Conditions: (Frequency: 11.8 MHz, Power: 1.0 KW, Coil: 5-turn
oval solenoid (2 × ½-in), Length: 2-in, Coil Current: 80 amps,
Matrix: High Density Polyethylene (HDPE)).

| | Heating Rate |
|---|---|
| Heating Agents | (° F./sec) |
| 36 w/o (20 v/o) Strontium Ferrite - 1.4 μm | 1050-1120 |
| 41 w/o (13 v/o) Flake Nickel - D: 10-20 μm | |
| t: 0.5 μm | |
| 46 w/o (20 v/o) Strontium Ferrite - 1.4 μm | 690-760 |
| 20.6 w/o (5 v/o) Wflake Nickel - D: 65-95 μm | |
| t: 0.5 μm | |
| 44.9 w/o (20 v/o) Mn—Zn Ferrite - 14 μm | 680-740 |
| 20.8 w/o (5 v/o) Flake 97Ni-3Al - D: 10-20 μm | |
| t: 0.5 μm | |
| 36 w/o (20 v/o) Mn—Zn Ferrite - 14 μm | 680-740 |
| 40 w/o (13 v/o) Iron < 44 μm (−325 mesh) | |

### Example 3:

Heating agents having HDPE as the matrix and containing from 10 ^{v}/ₒ to 30 ^{v}/ₒ micron-sized, non-conducting, ferrinmagnetic particles and 13 ^{v}/ₒ micron-sized, electrically conducting ICP particles, are fabricated into films, sheets or other shapes suitable for the intended application by the method described in Example 1. The said heating agents also can be fabricated by solution casting, extrusion compounding, extrusion compounding followed by compression injection molding or by a number of other methods known by those well versed in the technology. Both the non-conducting and conducting particles can be irregular or spherical in shape. These non-conducting susceptors also can be in the form of fibers or flakes.

The invention has been described in detail with particular references to the preferred embodiments thereof. However, it will be appreciated that modifications and improvements within the spirit and scope of this invention may be made by those skilled in the art upon considering the present disclosure.

All references cited are incorporated herein by reference.

We claim:

1. A heating agent for heating thermoplastic materials comprising (a) electrically non-conductive susceptors and (b) electrically conductive susceptors.

2. The agent according to claim 1, wherein the electrically non-conductive susceptors comprise micron-sized ferrimagnetic particles.

3. The agent according to claim 1, wherein the electrically conductive susceptors comprise ferromagnetic particles.

4. The agent according to claim 1, wherein the electrically non-conductive susceptors have a size of from about 1.0 μm to about 50 μm.

5. The agent according to claim 1, wherein the electrically conductive susceptors have a size of from about 5 μm to about 100 μm.

6. The agent according to claim 5, wherein the electrically conductive susceptors have a size of from about 10 μm to about 50 μm.

7. The agent according to claim 2-6, wherein the electrically non-conductive susceptors comprise iron oxide particles, hexagonal ferrite particles, or magnetically soft ferrite particles.

8. The agent according to claim 7, wherein the hexagonal ferrites have the composition SrF, Meₐ-2W, Meₐ-2Y, and Meₐ-2Z, wherein 2W is BaO:2MeₐO:8Fe₂O₃, 2Y is 2(BaO:MeₐO:3Fe₂O₃), and 2Z is 3BaO:2MeₐO:12Fe₂O₃, and wherein Meₐ is a divalent cation, and the magnetically soft ferrite particles have the composition 1Me_{b}O:1Fe₂O₃, where Me_{b}O is a transition metal oxide.

9. The agent according to claim 8, wherein the Meₐ comprises Mg, Co, Mn or Zn and Me_{b} comprises Ni, Co, Mn, or Zn.

10. The agent according to claims 1, wherein the electrically conductive susceptors comprise elemental ferromagnetic particles or ferromagnetic alloys.

11. The agent according to claim 1, wherein the electrically non-conductive susceptors comprise from about 10^{v}/ₒ (20 ^{w}/ₒ) to about 30^{v}/ₒ (58 ^{w}/ₒ).

12. The agent according to claims 1, wherein the electrically conductive susceptors comprise nickel, iron, and cobalt and combinations thereof and of their alloys.

13. The agent according to claim 1, wherein the electrically conductive susceptors comprise an intrinsically conductive polymer (ICP).

14. The agent according to claim 1, wherein the electrically conductive susceptors comprise from about 5^{v}/ₒ to about 15^{v}/^{o}.

15. The agent according to claim 13, wherein the intrinsically conductive polymer comprises polyaniline, polypyrrole, polythiophene, polyethylenedioxythiophene, and poly (p-phenylene vinylene).

16. A welding agent comprising (a) a matrix material and (b) an agent for heating the material, wherein the agent comprises (1) at least one plurality of electrically non-conductive susceptors and (2) at least one plurality of electrically conductive susceptors.

17. The agent according to claim 16, wherein the electrically non-conductive susceptors comprise micron-sized ferrimagnetic particles.

18. The agent according to claim 16, wherein the electrically conductive susceptors comprise ferromagnetic or ICP particles.

19. The agent according to claim 16, wherein the ferrimagnetic particles have a size of from about 1.0 μm to about 50 μm.

20. The agent according to claim 18, wherein the electrically conductive susceptors have a size of from about 5 μm to about 100 μm.

21. The agent according to claim 20, wherein the electrically conductive susceptors have a size of from about 10 μm to about 50 μm.

22. The agent according to claim 16-21, wherein the electrically non-conductive susceptors comprise iron oxides, hexagonal ferrites, or magnetically soft ferrite particles.

23. The agent according to claim 22, wherein the hexagonal ferrites have the composition SrF, Meₐ-2W, Meₐ-2Y, and Meₐ-2Z, wherein 2W is BaO:2MeₐO:8Fe₂O₃, 2Y is 2(BaO:MeₐO:3Fe₂O₃), and 2Z is 3BaO:2MeₐO:12Fe₂O₃, and wherein Meₐ is a divalent cation, and the magnetically soft ferrite particles have the composition 1Me_{b}O:1Fe₂O₃, where Me_{b}O is a transition metal oxide.

24. The agent according to claim 23, wherein the Meₐ comprises Mg, Co, Mn or Zn and Me_{b} comprises Ni, Co, Mn, or Zn.

25. The agent according to claim 16, wherein the electrically conductive susceptors comprise elemental ferromagnetic particles or ferromagnetic alloys particles.

26. The agent according to claim 25, wherein the electrically conductive susceptors comprise nickel, iron, and cobalt and combinations thereof and of their alloys.

27. The agent according to claim 16, wherein the electrically non-conductive susceptors comprise from about 10^{v}/ₒ (20 ^{w}/ₒ) to about 30^{v}/ₒ (58 ^{w}/ₒ).

28. The agent according to claim 16, wherein the electrically conductive susceptors comprise from about 5^{v}/ₒ to about 15^{v}/ₒ.

29. The agent according to claims 16, wherein the electrically conductive susceptors comprise an intrinsically conductive polymer (ICP).

30. The agent according to claim 29, wherein the intrinsically conductive polymer comprises polyaniline, polypyrrole, polythiophene, polyethylenedioxythiophene, and poly(p-phenylene vinylene).

31. The agent according to claims 16, wherein the matrix material comprises at least one thermoplastic material.

32. An article of manufacture comprising (a) a matrix material and (b) an agent for heating the material, wherein the agent comprises (1) at least one plurality of electrically non-conductive susceptors and (2) at least one plurality of electrically conductive susceptors.

33. The article according to claim 32, wherein the electrically non-conductive susceptors comprise micron-sized ferrimagnetic particles.

34. The article according to claims 32-33, wherein the electrically conductive susceptors comprise ferromagnetic particles.

35. The article according to claims 32-34, wherein the electrically conductive susceptors comprise intrinsically conductive polymer (ICP) particles.

36. The article according to claim 32, wherein the electrically non-conductive susceptors have a size of from about 1.0 μm to about 50 μm.

37. The article according to claim 32, wherein the electrically conductive susceptors have a size of from about 5 μm to about 100 μm.

38. The article according to claim 37, wherein the electrically conductive susceptors have a size of from about 10 μm to about 50 μm.

39. The article according to claim 32, wherein the electrically non-conductive susceptors comprise iron oxides, hexagonal ferrites, or magnetically soft ferrite particles.

40. The article according to claim 32, wherein the electrically conductive susceptors comprise elemental ferromagnetic particles or ferromagnetic alloys.

41. The article according to claim 40, wherein the electrically conductive susceptors comprise nickel, iron, and cobalt, and combinations thereof and of their alloys.

42. The article according to claim 32, wherein the electrically non-conductive susceptors comprise from about 10^{v}/ₒ (20 ^{w}/ₒ) to about 30^{v}/ₒ (58 ^{w}/ₒ).

43. The article according to claim 32, wherein the electrically conductive susceptors comprise from about 5^{v}/ₒ to about 15^{v}/ₒ.

44. The article according to claim 32, wherein the matrix material comprises at least one polymeric material or at least one ceramic material.

45. The article according to claim 32, wherein the electrically conductive susceptors comprise an intrinsically conductive polymer (ICP) particles.

46. The article according to claim 32-45, wherein the susceptors are on a surface of the matrix material.

47. The article according to claim 32-45, wherein the susceptors are embedded in the matrix material.

48. A method of rapid heating of a thermoplastic material comprising
(a) providing a first thermoplastic material,
(b) providing at least one plurality of electrically non-conductive susceptors having a specific Curie temperature (T_{c}) in the first thermoplastic material,
(c) providing at least one plurality of electrically conductive susceptors,
(d) applying an alternating magnetic field to the first thermoplastic material to heat the susceptors, and
(e) ceasing the applying of the alternating magnetic field when the susceptors reach the desired temperature.

49. The method of claim 48, wherein T_{c} of the susceptors in (b) is less than the melting temperature of the thermoplastic material.

50. The method of claim 48, wherein T_{c} of the susceptors in (b) is greater than the melting temperature of the thermoplastic material, and the magnetic field is applied so that the susceptors melt the first thermoplastic material.

51. The method of claim 48, further comprising the step of providing a second thermoplastic material in contact with the first thermoplastic material before applying the alternating magnetic field.

52. The method of claim 48-51, further comprising initially placing the first thermoplastic material on an uncured or partially cured thermoset material and bonding the thermoplastic material and the thermoset material while curing the thermoset material.

53. The method of claim 48-52, further comprising initially juxtaposing the first thermoplastic material on the thermoset material, bonding the thermoplastic to the thermoset while curing the thermoset material, and juxtaposing the bonded assembly with the second material.

54. The method of claim 53, wherein the second material is a second thermoset material with a second thermoplastic material and wherein the bonding comprises flowing and bonding the first and second thermoplastic materials while curing the thermoset material.

55. The method of claim 51, wherein the second material is a second thermoplastic material.

56. The method of claim 51, where the second material has a different chemical composition than the first thermoplastic material.

57. The method of claim 51, wherein the second thermoplastic material has susceptors embedded therein.

58. The method of claim 51, wherein the susceptors are embedded in adjacent surfaces of the first and second thermoplastic materials.

59. The method of claim 51, wherein the susceptors are embedded in a surface of the first or second thermoplastic material.

60. The method of claim 48, wherein the applying comprises applying an alternating magnetic field at about 2 MHz to about 30 MHz.

61. The method of claim 60, wherein the applying comprises applying an alternating magnetic field at about 10 MHz to about 15 MHz.

62. The method according to claim 48, wherein the electrically non-conductive susceptors comprise iron oxides, hexagonal ferrites, or magnetically soft ferrite particles.

63. The method according to claim 48, wherein the electrically conductive susceptors comprise elemental ferromagnetic particles, ferromagnetic alloy particles or ICP particles.

64. A method of rapid heating of a polymeric material comprising
(a) providing at least one polymeric material,
(b) heating the polymeric material,
(c) dispersing at least one plurality of electrically non-conductive susceptors having a specific Curie temperature (T_{c}) in the polymeric material,
(d) dispersing at least one plurality of electrically conductive susceptors,
(e) forming the polymeric material,
(f) applying an alternating magnetic field to the polymeric material,
(g) heating the susceptors and heating the polymeric material, and
(h) ceasing the application of the alternating field when the susceptors reach the desired temperature.

65. The method according to claim 64, wherein the applying comprises applying an alternating magnetic field at about 2 MHz to about 30 MHz.

66. The method according to claim 64, wherein the applying comprises applying an alternating magnetic field at about 10 MHz to about 15 MHz.

67. The method according to claim 64, wherein the electrically non-conductive susceptors comprise iron oxides, hexagonal ferrites, or magnetically soft ferrite particles.

68. The method according to claim 64, wherein the electrically conductive susceptors comprise elemental ferromagnetic particles or ferromagnetic alloy particles.

69. The method of claim 68, further comprising varying the amount of zinc in the ferromagnetic particle as to control the Curie temperature of the particles.

70. The method according to claim 64, wherein the matrix material comprises at least one thermoplastic material.

71. The method according to claim 64, wherein the electrically conductive susceptors comprise ICP particles.

72. A method of heating a material comprising
(a) providing at least one plurality of electrically non-conductive susceptors in the material having a specific Curie temperature (T_{c}) in the material,
(b) providing at least one plurality of electrically conductive susceptors in the material,
(c) applying an alternating magnetic field to the material, wherein the susceptors in (a) generate heat due to hysteresis loss and the susceptors in (b) generate heat due to eddy current flow.

73. The method of claim 72, wherein the applying comprises applying an alternating magnetic field at about 2 MHz to about 30 MHz.

74. The method of claim 73, wherein the applying comprises applying an alternating magnetic field at about 10 MHz to about 15 MHz.

75. The method according to claim 72, wherein the electrically non-conductive susceptors comprise iron oxides, hexagonal ferrites, or magnetically soft ferrite particles.

76. The method according to claim 72, wherein the electrically conductive susceptors comprise elemental ferromagnetic particles or ferromagnetic alloys.

77. The method according to claim 76, wherein the electrically conductive susceptors comprise nickel, iron, cobalt, aluminum and combinations thereof and of their alloys.

78. The method according to claim 72, wherein the matrix material comprises at least one polymeric material or at least one ceramic material.

79. The method according to claim 72, wherein the electrically conductive susceptors comprise ICP particles.

80. A sealable apparatus comprising
a first element having a shaped matrix and having a rim;
a second element having an annular area for bonding to the rim of the first element,
at least one plurality of electrically non-conductive susceptors and at least one plurality of electrically conductive susceptors disposed in the rim of the first element or in the annular area of the second element, for heating the rim or the annular area to a desired temperature upon application of an alternating magnetic field, for bonding the first element and the second element together.

81. The apparatus according to claim 80, wherein the susceptors are disposed in both the rim and the annular area.

82. The apparatus according to claim 80, wherein the matrix comprises a thermoplastic material.

83. The apparatus according to claim 80, wherein the electrically non-conductive susceptors comprise micron-sized ferrimagnetic particles.

84. The apparatus according to claim 80, wherein the electrically conductive susceptors comprise ferromagnetic particles or ICP particles.

85. The apparatus according to claim 83, wherein the electrically non-conductive susceptors have a size of from about 1.0 μm to about 50 μm.

86. The apparatus according to claim 80, wherein the electrically conductive susceptors have a size of from about 5 μm to about 100 μm.

87. The apparatus according to claim 86, wherein the electrically conductive susceptors have a size of from about 10 μm to about 50 μm.

88. The apparatus according to claim 80, wherein the electrically non-conductive susceptors comprise iron oxides, hexagonal ferrites, or magnetically soft ferrite particles.

89. The apparatus according to claim 80, wherein the electrically conductive susceptors comprise elemental ferromagnetic particles or ferromagnetic alloys.

90. The apparatus according to claim 80, wherein the matrix material comprises at least one thermoplastic material.
